(19) United States
(12) Patent Application Publication
(10) Pub. No.: US 2006/0212371 A1
(43) Pub. Date: Sep. 21, 2006

(54) System and method for generating material inventory list

(75) Inventor: Yung-Chien Cheng, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/084,478

(22) Filed: Mar. 18, 2005

(51) Int. Cl. G06F 17/60

(52) U.S. Cl. 705/29

(57) ABSTRACT

A system and a method for generating material inventory list are provided for allowing a user to input data of basic modules and various accessories of a required product based on a type of the product so as to generate a material inventory list of the product. The system includes a material inventory database for storing material basic data, basic module material data, accessory material data and product material data; a data input module for allowing the user to select the basic modules and accessories of the required product; a data access module for accessing corresponding material data stored in the material inventory database to generate the material inventory list of the product; and a report generating module for generating a material inventory report of the product. This can simplify procedures of generating a material inventory list and increase accuracy of the generated material inventory list.

### FIELD OF THE INVENTION

The present invention relates to methods and systems for generating material inventory lists, and more particularly, to a system and a method for generating a material inventory list of a product based on material data of basic modules and various accessories of the product which are inputted according to a type of the product.

### BACKGROUND OF THE INVENTION

Generally, a material inventory list is generated according to the arrangement of a circuit diagram after being completed, wherein a conventional mode for generating the material inventory list relies on manual input of material data of parts of each product. However, for information communication products such as a mobile phone, personal computer (PC), personal digital assistant (PDA) and so on, each of the products comprises a plurality of parts, and each of the parts comprises a plurality of materials, thereby making a material inventory list of the product relatively vast and contain a large number of materials and complex types thereof. As a result, the conventional manual method of typing and generating the material inventory list for each product is not only time- and labor-consuming but also easy to cause mistakes due to complex operation.

Moreover, since the types of models of information communication products are numerous, and there is often a minor difference in parts between different models of the products, thus the conventional manual method of inputting material data of the products is inefficient due to mostly repeated input works for similar material data of different products, and is also easy to cause confusion and mistakes further due to different products containing similar material data.

### SUMMARY OF THE INVENTION

In light of the above prior-art drawbacks, a primary objective of the present invention is to provide a system and a method for generating material inventory list, which allow a user to input basic modules and various accessories of a required product according to a type of the product and access material data of the basic modules and accessories so as to automatically generate a material inventory list of the product, such that manpower and time can be effectively saved, and mistakes caused by the conventional manual technique for generating material inventory list can be avoided, as well as confusion and mistakes incurred in inputting material data for different products containing similar accessories by the conventional manual technique can be prevented.

In accordance with the above and other objectives, the present invention proposes a system for generating material inventory list, the system comprising: a material inventory database for storing material related data of products including material basic data, basic module material data, accessory material data and product material data, etc., which are required for generating a material inventory list of each product; a data input module for allowing a user to input data of basic modules and various accessories of a required product, which are required for generating a material inventory list of the product; a data access module for reading corresponding material data stored in the material inventory database according to the data of basic modules and accessories inputted via the data input module so as to generate the material inventory list of the product, and for storing the material inventory list into the material inventory database; and a report generating module for allowing the user to read the material inventory list of the product to generate a material inventory report. This can prevent mistakes possibly caused by the conventional manual technique for generating material inventory list and avoid consumption of manpower and time in repeated works.

The present invention also proposes a method for generating material inventory list, comprising the steps of: firstly, storing serial numbers and names of materials for products into a material inventory database, and storing serial numbers, names and material serial numbers of basic modules of the products into the material inventory database, and further storing serial numbers, names and material serial numbers of accessories of the products into the material inventory database; inputting data of basic modules and various accessories of a required product, and reading corresponding material data from the material inventory database according to the inputted data of basic modules and accessories so as to generate a material inventory list of the product; and finally, storing the material inventory list of the basic modules and accessories of the product into the material inventory database, and reading the material inventory list to generate a material inventory report serving as reference for fabrication of the product.

By the system and method for generating material inventory list in the present invention, firstly, material basic data, basic module material data and accessory material data of products are stored into a material inventory database. A data input module is actuated for inputting data of basic modules and various accessories of a required product. Subsequently, a data access module is actuated to read corresponding data from the material inventory database according to the inputted data of basic modules and accessories to generate a material inventory list of the product, and store the material inventory list into the material inventory database. Finally, a report generating module is actuated to produce a material inventory report of the product. Therefore, the system and method in the present invention can prevent mistakes possibly caused by the conventional manual technique for generating material inventory list and avoid consumption of manpower and time in repeated works.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing a basic structure of a system for generating material inventory list according to the present invention;

FIG. 2 is a flowchart showing steps of a method for generating material inventory list according to the present invention; and

FIG. 3 is a flowchart showing steps for establishing a material inventory database by the method for generating material inventory list according to the present invention.

### DETAILED DESCRIPTION OF THE PREFERRED EMBODIMENTS

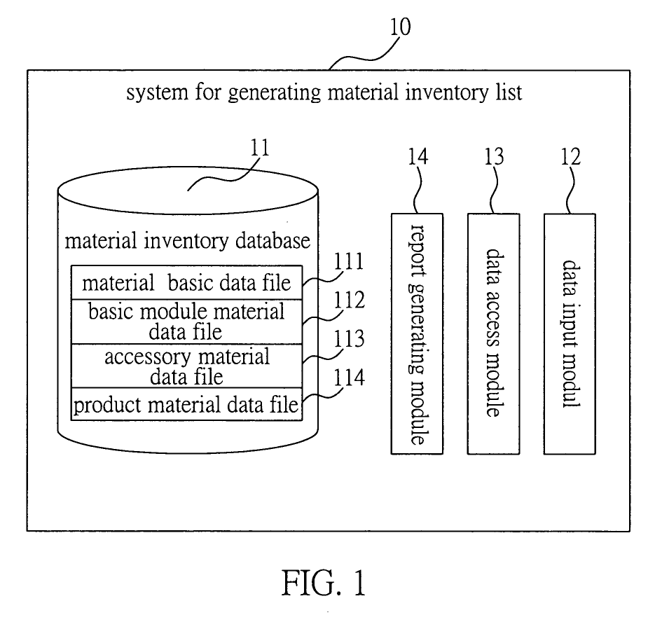

Preferred embodiments of a system and a method for generating material inventory list proposed in the present invention are described in detail as follows with reference to FIGS. 1 to 3.

FIG. 1 is a schematic block diagram showing a basic structure of the system for generating material inventory list according to the present invention. As shown in FIG. 1, the system for generating material inventory list 10 in the present invention comprises: a material inventory database 11, a data input module 12, a data access module 13 and a report generating module 14. The system for generating material inventory list 10 in the present invention can be built in a server or workstation, for allowing a user at a terminal device (not shown) to be connected to the server or workstation through a network system such as Internet or LAN (local area network) to select basic modules and various accessories of a required product, such that a corresponding material inventory list can be automatically generated according to the basic modules and accessories of the product selected by the user.

Besides, the system for generating material inventory list 10 in the present invention can also be installed on a computer device to work as a single unit for directly providing services of the system 10 to the user via the computer device.

The material inventory database 11 comprises a material basic data file 111, a basic module material data file 112, an accessory material data file 113 and a product material data file 114. The material basic data file 111 comprises material serial numbers and material names, for storing basic data of materials required for fabricating products. The basic module material data file 112 comprises serial numbers, names and material serial numbers of basic modules, for storing related data of materials required for fabricating basic modules of the products. Basic modules refer to common modules used by different models of products. For example, different models of computers often employ motherboards, CPUs (central processing units), memory units and hard disks that have the same specifications, and only differ in whether additionally including USB (universal serial bus) ports, wireless network cards and/or bluetooth wireless transmission interfaces, such that the basic modules thereof refer to the motherboards, CPUs, memory units and hard disks that have the same specifications in the computers. The accessory material data file 113 comprises serial numbers, names and material serial numbers of accessories, for storing related data of materials required for accessories of the products. Accessories refer to equipment in addition to the basic modules of different models of products. In the foregoing example, the accessories are different species of equipment such as the USB ports, wireless network cards and/or bluetooth wireless transmission interfaces for the different models of computers. The product material data file 114 comprises product serial numbers, basic module serial numbers, accessory serial numbers and material serial numbers, for storing material data of basic modules and various accessories of the products, so as to generate a material inventory list of each product according to the material data.

The data input module 12 is used to receive data of basic modules and various accessories of a required product inputted by the user, so as to read corresponding material data of the product stored in the material inventory database 11 which are required for generating a material inventory list of the product. Generally, the system for generating material inventory list 10 in the present invention provides a selection list (not shown) showing product contents (i.e. basic modules and various accessories thereof) for the user before selecting a required product, such that the user can use the selection list to select the required product to be received by the data input module 12.

The data access module 13 is used to retrieve data of materials required for fabricating the basic modules and accessories of the required product from the basic module material data file 112 and the accessory material data file 113 stored in the material inventory database 11 according to the data of basic modules and accessories received by the data input module 12, so as to generate the material inventory list for the required product and store the material inventory list into the product material data file 114 in the material inventory database 11.

The report generating module 14 is used to read material serial numbers required for the required product from the product material data file 114 in the material inventory database 11, and read corresponding material names from the material basic data file 111 according to the material serial numbers, so as to generate a material inventory report of the required product.

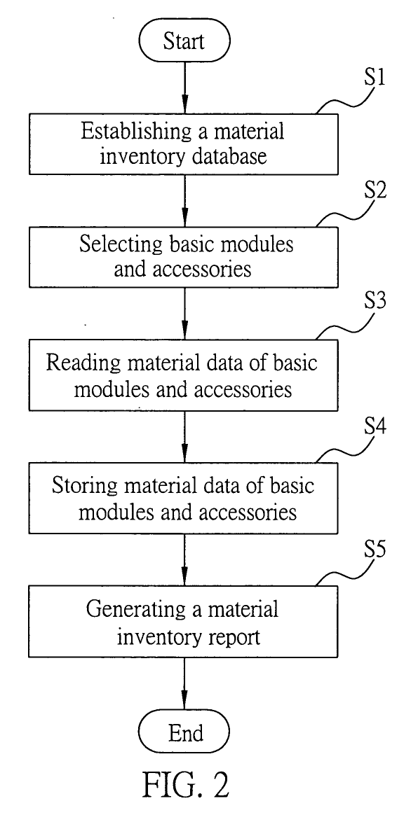

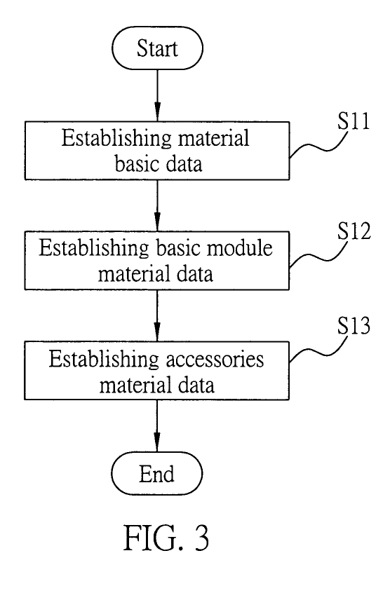

FIG. 2 illustrates steps of the method for generating material inventory list in the use of the system for generating material inventory list 10 according to the present invention. As shown in FIG. 2, firstly, in step S1, the material inventory database 11 is established, and detailed procedures thereof are disclosed in FIG. 3 and described later. Then, it proceeds to step S2.

In step S2, the data input module 12 allows a user to select corresponding basic modules and accessories listed in the basic module material data file 112 and the accessory material data file 113 in the material inventory database 11 according to basic modules and various accessories of a required product. Then, it proceeds to step S3.

In step S3, the data access module 13 retrieves corresponding material data required for the basic modules and accessories of the required product from the basic module material data file 112 and the accessory material data file 113 in the material inventory database 11 according to the basic modules and accessories of the product received by the data input module 12, so as to generate a material inventory list of the required product. Then, it proceeds to step S4.

In step S4, the data access module 13 stores the material inventory list of the product into the product material data file 114 in the material inventory database 11. Then, it proceeds to step S5.

In step S5, the report generating module 14 reads material serial numbers of the required product from the product material data file 114 in the material inventory database 11, and reads corresponding material names from the material basic data file 111 according to the material serial numbers, so as to generate a material inventory report of the product.

FIG. 3 illustrates detailed procedures of step S1 in FIG. 2 for establishing data files in the material inventory database 11. As shown in FIG. 3, firstly, in step S11, material serial numbers and material names required for various types of products for a manufacturer are stored into the material basic data file 111 in the material inventory database 11, for allowing the user to input material data of a required product which are required for generating a material inventory list of the product. Then, it proceeds to step S12.

In step S12, serial numbers, names and material serial numbers of basic modules of the various types of products for the manufacturer are stored into the basic module material data file 112 in the material inventory database 11 so as to form data of materials required for fabricating basic modules of the products. Basic modules refer to common modules used by different models of products. For example, different models of computers often employ motherboards, CPUs, memory units and hard disks that have the same specifications, and only differ in whether additionally including USB ports, wireless network cards and/or bluetooth wireless transmission interfaces. Therefore, the basic modules thereof refer to the motherboards, CPUs, memory units and hard disks that have the same specifications in the computers. Then, it proceeds to step S13.

In step S13, serial numbers, names and material serial numbers of accessories of the various types of products for the manufacturer are stored into the accessory material data file 113 in the material inventory database 11 so as to form data of materials required for fabricating various accessories of the products. Accessories refer to equipment in addition to the basic modules of different models of products. For instance, in the foregoing example, the accessories refer to different species of equipment such as the USB ports, wireless network cards and/or bluetooth wireless transmission interfaces for the different models of computers.

By the system and method for generating material inventory list in the present invention, firstly, material basic data, basic module material data and accessory material data of products are stored into a material inventory database. A data input module is actuated for inputting data of basic modules and various accessories of a required product. Subsequently, a data access module is actuated to read corresponding data from the material inventory database according to the inputted data of basic modules and accessories to generate a material inventory list of the product, and store the material inventory list into the material inventory database. Finally, a report generating module is actuated to produce a material inventory report of the product. Therefore, the system and method in the present invention can prevent mistakes possibly caused by the conventional manual technique for generating material inventory list and avoid consumption of manpower and time in repeated works.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A system for generating material inventory list, comprising:
a material inventory database for at least storing basic module material related data and accessory material related data;
a data input module for receiving data of basic modules and accessories of a required product; and
a data access module for reading corresponding data from the material inventory database according to the data of basic modules and accessories received by the data input module, so as to generate a material inventory list of the product.

2. The system of claim 1, wherein the data access module is further for storing the material inventory list of the product into the material inventory database.

3. The system of claim 1, further comprising a report generating module for reading the material inventory list of the product from the material inventory database so as to generate a material inventory report of the product.

4. A method for generating material inventory list, comprising the steps of:
storing material related data of products at least having basic module material data and accessory material data into a material inventory database;
inputting data of basic modules and accessories of a required product via a user; and
retrieving corresponding material data of basic modules and accessories from the material inventory database according to the inputted data of basic modules and accessories so as to generate a material inventory list of the product.

5. The method of claim 4, further comprising a step of storing the material inventory list of the product into the material inventory database.

6. The method of claim 5, further comprising a step of reading the material inventory list of the product from the material inventory database to generate a material inventory report of the product.
